(19) United States
(12) Patent Application Publication
(10) Pub. No.: US 2023/0101573 A1
(43) Pub. Date: Mar. 30, 2023

(54) AEROSOL PROVISION SYSTEM

(71) Applicant: Nicoventures Trading Limited, London (GB)

(72) Inventors: Patrick Moloney, London (GB); Sean Lukan, London (GB)

(21) Appl. No.: 17/448,823

(22) Filed: Sep. 24, 2021

(51) Int. Cl. A24F 40/60; A24F 40/50; A24F 40/42; A24F 40/70; G09B 21/00

(52) U.S. Cl. CPC A24F 40/60; A24F 40/50; A24F 40/42; A24F 40/70; G09B 21/003

(57) ABSTRACT

A tactile indicator 200 for use in an aerosol provision system 300. The tactile indicator 200 may be supplied with a given aerosol provision system 1, or may be retrospectively used with, or attached to, an aerosol provision device 2. The tactile indicator 200 may be electrically operated, or may be mechanically operated and/or configured to remain stationary in use. The tactile indicator 200 may therefore facilitate the operation of an aerosol provision system 1, particularly to those users which have a visual impairment.

### TECHNICAL FIELD

The present disclosure relates to aerosol provision systems such as, but not limited to, nicotine delivery systems (e.g. electronic cigarettes and the like).

### BACKGROUND

Electronic aerosol provision systems often employ an electronic cigarette (e-cigarette) or more generally an aerosol provision device. Such an aerosol provision system typically contains aerosolizable material (also called aerosol-generating material), such as a reservoir of fluid or liquid containing a formulation, typically but not necessarily including nicotine, or a solid material such as a tobacco-based product, from which a vapor/aerosol is generated for inhalation by a user, for example through heat vaporization. Thus, an aerosol provision system will typically comprise a vaporizer (also called an aerosol generator), e.g. a heating element, arranged to aerosolize a portion of aerosolizable material to generate a vapor.

Once a vapor has been generated, the vapor may be passed through flavoring material to add flavor to the vapor (if the aerosolizable material was not itself flavored), after which the (flavored) vapor may be then delivered to a user via a mouthpiece from the aerosol provision device.

A potential drawback of existing aerosol provision systems and associated aerosol provision devices is that, particularly for those with a visual impairment, it can be challenging to discern particular characteristics or operations of aerosol provision systems, and/or any aerosol provision devices therefrom. Various approaches are therefore described herein which seek to help address or mitigate some of the issues discussed above.

### SUMMARY

According to a first aspect of certain embodiments there is provided an aerosol provision system comprising:
an aerosol provision device for generating an aerosol; and
a tactile indicator for providing an indication of an operation or characteristic of the aerosol provision system.

According to a second aspect of certain embodiments there is provided a cartridge for an aerosol provision system comprising the cartridge and an aerosol provision device, wherein the cartridge comprises:
a tactile indicator for providing an indication of an operation or characteristic of the aerosol provision system.

According to a third aspect of certain embodiments there is provided a tactile indicator for providing an indication of an operation or characteristic of an aerosol provision system, wherein the tactile indicator is configured to be attached to an aerosol provision system;
wherein the tactile indicator comprises an adhesive surface for attaching the tactile indicator to the aerosol provision system.

According to a fourth aspect of certain embodiments there is provided an aerosol provision device for generating an aerosol in an aerosol provision system, wherein the aerosol provision device further comprises a tactile indicator for providing an indication of an operation or characteristic of the aerosol provision system

According to a fifth aspect of certain embodiments there is provided a method of providing an indication of an operation or characteristic of an aerosol provision system configured to generate an aerosol, the method comprising:
in response to a first predetermined criterion being satisfied, changing a configuration of the tactile indicator from a first configuration to a second configuration.

According to a sixth aspect of certain embodiments there is provided a method of retrofitting an aerosol provision system, comprising an aerosol provision device for generating an aerosol, wherein the method comprises:
attaching a tactile indicator, for providing an indication of an operation or characteristic of the aerosol provision system, to the aerosol provision system.

It will be appreciated that features and aspects of the invention described above in relation to the various aspects of the invention are equally applicable to, and may be combined with, embodiments of the invention according to other aspects of the invention as appropriate, and not just in the specific combinations described herein.

### BRIEF DESCRIPTION OF THE DRAWINGS

Embodiments of the invention will now be described, by way of example only, with reference to the accompanying drawings, in which:

FIG. 1 schematically represents in perspective view an aerosol provision system comprising a cartridge and aerosol provision device (shown separated) in accordance with certain embodiments of the disclosure;

FIG. 2 schematically represents in exploded perspective view of components of the cartridge of the aerosol provision system of FIG. 1;

FIGS. 3A to 3C schematically represent various cross-section views of a housing part of the cartridge of the aerosol provision system of FIG. 1;

FIGS. 4A and 4B schematically represent a perspective view and a plan view of a dividing wall element of the cartridge of the aerosol provision system of FIG. 1;

FIGS. 5A to 5C schematically represent two perspective views and a plan view of a resilient plug of the cartridge of the aerosol provision system of FIG. 1;

FIGS. 6A and 6B schematically represent a perspective view and a plan view of a bottom cap of the cartridge of the aerosol provision system of FIG. 1;

FIG. 7 schematically represents embodiments of aerosol provision system, useable with an aerosol provision system such as that shown in FIGS. 1-6B, and comprising a tactile indicator;

FIG. 8 schematically represents embodiments of aerosol provision system, useable with an aerosol provision system such as that shown in FIGS. 1-6B, and comprising a tactile indicator;

FIG. 9A schematically represents schematically represents embodiments of aerosol provision system, useable with an aerosol provision system such as that shown in FIGS. 1-6B, and comprising a tactile indicator;

FIG. 9B schematically represents a particular embodiment, relating to the disclosure from FIG. 9A, and which comprises a tactile indicator;

FIG. 9C schematically represents a particular embodiment, relating to the disclosure from FIG. 9A, and which comprises a tactile indicator; and

FIG. 10 schematically represents embodiments of aerosol provision system, useable with an aerosol provision system such as that shown in FIGS. 1-6B, and comprising a tactile indicator.

### DETAILED DESCRIPTION OF THE DRAWINGS

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to non-combustible aerosol provision systems (such as an e-cigarette). According to the present disclosure, a “non-combustible” aerosol provision system is one where a constituent aerosolizable material of the aerosol provision system (or component thereof) is not combusted or burned in order to facilitate delivery to a user. Aerosolizable material, which also may be referred to herein as aerosol generating material or aerosol precursor material, is material that is capable of generating aerosol, for example when heated, irradiated or energized in any other way. The aerosolizable material may also be flavored, in some embodiments.

Throughout the following description the term “e-cigarette” or “electronic cigarette” may sometimes be used, but it will be appreciated this term may be used interchangeably with an aerosol provision system. An electronic cigarette may also known as a vaping device or electronic nicotine delivery system (END), although it is noted that the presence of nicotine in the aerosolizable material is not a requirement.

In some embodiments, the aerosol provision system is a hybrid device configured to generate aerosol using a combination of aerosolizable materials, one or a plurality of which may be heated. In some embodiments, the hybrid device comprises a liquid or gel aerosolizable material and a solid aerosolizable material. The solid aerosolizable material may comprise, for example, tobacco or a non-tobacco product.

Typically, the (non-combustible) aerosol provision system may comprise a cartridge/consumable part and a body/reusable/aerosol provision device part, which is configured to releasably engage with the cartridge/consumable part.

The aerosol provision system may be provided with a means for powering a vaporizer therein, and there may be provided an aerosolizable material transport element for receiving the aerosolizable material that is to be vaporized. The aerosol provision system may also be provided with a reservoir for containing aerosolizable material, and in some embodiments a further reservoir for containing flavoring material for flavoring a generated vapor from the aerosol provision system.

In some embodiments, the vaporizer may be a heater/heating element capable of interacting with the aerosolizable material so as to release one or more volatiles from the aerosolizable material to form a vapor/aerosol. In some embodiments, the vaporizer is capable of generating an aerosol from the aerosolizable material without heating. For example, the vaporizer may be capable of generating a vapor/aerosol from the aerosolizable material without applying heat thereto, for example via one or more of vibrational, mechanical, pressurisation or electrostatic means.

In some embodiments, the substance to be delivered may be an aerosolizable material which may comprise an active constituent, a carrier constituent and optionally one or more other functional constituents.

The active constituent may comprise one or more physiologically and/or olfactory active constituents which are included in the aerosolizable material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, theine, a vitamin such as B6 or B12 or C, melatonin, a cannabinoid, or a constituent, derivative, or combinations thereof. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine, or mixtures thereof.

In some embodiments, the active constituent is an olfactory active constituent and may be selected from a “flavor” and/or “flavorant” which, where local regulations permit, may be used to create a desired taste, aroma or other somatosensorial sensation in a product for adult consumers. In some instances such constituents may be referred to as flavors, flavorants, flavoring material, cooling agents, heating agents, and/or sweetening agents. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavoring material (flavor) may comprise menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, coloring agents, preservatives, binders, fillers, stabilizers, and/or antioxidants.

As noted above, aerosol provision systems (e-cigarettes) may often comprise a modular assembly including both a reusable part (body—or aerosol provision device) and a replaceable consumable (cartridge) part. Devices conforming to this type of two-part modular configuration may generally be referred to as two-part devices. It is also common for electronic cigarettes to have a generally elongate shape. For the sake of providing a concrete example, certain embodiments of the disclosure described herein may comprise this kind of generally elongate two-part device employing consumable parts. However, it will be appreciated the underlying principles described herein may equally be adopted for other electronic cigarette configurations, for example modular devices comprising more than two parts, as devices conforming to other overall shapes, for example based on so-called box-mod high performance devices that typically have a more boxy shape.

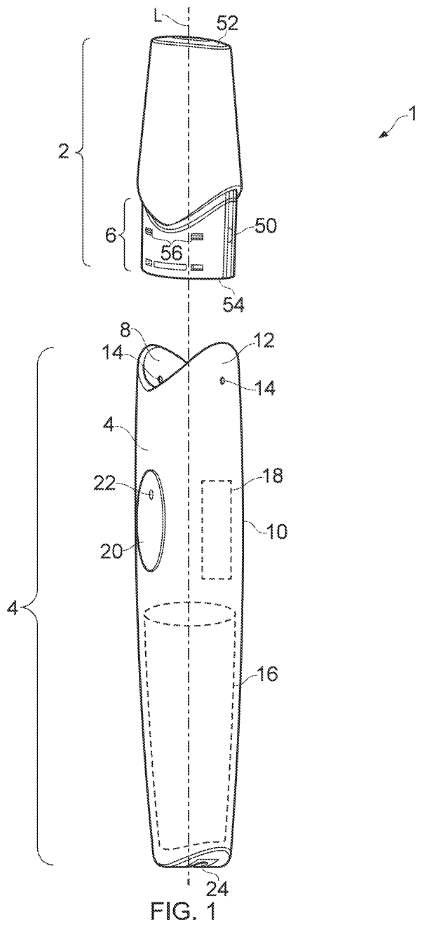

From the forgoing therefore, and with reference to FIG. 1 is a schematic perspective view of an example aerosol provision system (e-cigarette) 1 in accordance with certain embodiments of the disclosure. Terms concerning the relative location of various aspects of the electronic cigarette (e.g. terms such as upper, lower, above, below, top, bottom etc.) are used herein with reference to the orientation of the electronic cigarette as shown in FIG. 1 (unless the context indicates otherwise). However, it will be appreciated this is purely for ease of explanation and is not intended to indicate there is any required orientation for the electronic cigarette in use.

The e-cigarette 1 (aerosol provision system 1) comprises two main components, namely a cartridge 2 and an aerosol provision device 4. The aerosol provision device 4 and the cartridge 2 are shown separated in FIG. 1, but are coupled together when in use.

The cartridge 2 and aerosol provision device 4 are coupled by establishing a mechanical and electrical connection between them. The specific manner in which the mechanical and electrical connection is established is not of primary significance to the principles described herein and may be established in accordance with conventional techniques, for example based around a screw thread, bayonet, latched or friction-fit mechanical fixing with appropriately arranged electrical contacts/electrodes for establishing the electrical connection between the two parts as appropriate. For example electronic cigarette 1 represented in FIG. 1, the cartridge comprises a mouthpiece end 52 and an interface end 54 and is coupled to the aerosol provision device by inserting an interface end portion 6 at the interface end of the cartridge into a corresponding receptacle 8/receiving section of the aerosol provision device. The interface end portion 6 of the cartridge is a close fit to be receptacle 8 and includes protrusions 56 which engage with corresponding detents in the interior surface of a receptacle wall 12 defining the receptacle 8 to provide a releasable mechanical engagement between the cartridge and the aerosol provision device. An electrical connection is established between the aerosol provision device and the cartridge via a pair of electrical contacts on the bottom of the cartridge (not shown in FIG. 1) and corresponding sprung contact pins in the base of the receptacle 8 (not shown in FIG. 1). As noted above, the specific manner in which the electrical connection is established is not significant to the principles described herein, and indeed some implementations might not have an electrical connection between the cartridge and a aerosol provision device at all, for example because the transfer of electrical power from the reusable part to the cartridge may be wireless (e.g. based on electromagnetic induction techniques).

The electronic cigarette 1 (aerosol provision system) has a generally elongate shape extending along a longitudinal axis L. When the cartridge is coupled to the aerosol provision device, the overall length of the electronic cigarette in this example (along the longitudinal axis) is around 12.5 cm. The overall length of the aerosol provision device is around 9 cm and the overall length of the cartridge is around 5 cm (i.e. there is around 1.5 cm of overlap between the interface end portion 6 of the cartridge and the receptacle 8 of the aerosol provision device when they are coupled together). The electronic cigarette has a cross-section which is generally oval and which is largest around the middle of the electronic cigarette and tapers in a curved manner towards the ends. The cross-section around the middle of the electronic cigarette has a width of around 2.5 cm and a thickness of around 1.7 cm. The end of the cartridge has a width of around 2 cm and a thickness of around 0.6 mm, whereas the other end of the electronic cigarette has a width of around 2 cm and a thickness of around 1.2 cm. The outer housing of the electronic cigarette is in this example is formed from plastic. It will be appreciated the specific size and shape of the electronic cigarette and the material from which it is made is not of primary significance to the principles described herein and may be different in different implementations. That is to say, the principles described herein may equally be adopted for electronic cigarettes having different sizes, shapes and/or materials.

The aerosol provision device 4 may in accordance with certain embodiments of the disclosure be broadly conventional in terms of its functionality and general construction techniques. In the example of FIG. 1, the aerosol provision device 4 comprises a plastic outer housing 10 including the receptacle wall 12 that defines the receptacle 8 for receiving the end of the cartridge as noted above. The outer housing 10 of the aerosol provision device 4 in this example has a generally oval cross section conforming to the shape and size of the cartridge 2 at their interface to provide a smooth transition between the two parts. The receptacle 8 and the end portion 6 of the cartridge 2 are symmetric when rotated through 180° so the cartridge can be inserted into the aerosol provision device in two different orientations. The receptacle wall 12 includes two aerosol provision device air inlet openings 14 (i.e. holes in the wall). These openings 14 are positioned to align with an air inlet 50 for the cartridge when the cartridge is coupled to the aerosol provision device. A different one of the openings 14 aligns with the air inlet 50 of the cartridge in the different orientations. It will be appreciated some implementations may not have any degree of rotational symmetry such that the cartridge is couplable to the aerosol provision device in only one orientation while other implementations may have a higher degree of rotational symmetry such that the cartridge is couplable to the aerosol provision device in more orientations.

The aerosol provision device further comprises a battery 16 for providing operating power for the electronic cigarette, control circuitry 18 for controlling and monitoring the operation of the electronic cigarette, a user input button 20, an indicator light 22, and a charging port 24.

The battery 16 in this example is rechargeable and may be of a conventional type, for example of the kind normally used in electronic cigarettes and other applications requiring provision of relatively high currents over relatively short periods. The battery 16 may be recharged through the charging port 24, which may, for example, comprise a USB connector.

The input button 20 in this example is a conventional mechanical button, for example comprising a sprung mounted component which may be pressed by a user to establish an electrical contact in underlying circuitry. In this regard, the input button may be considered an input device for detecting user input, e.g. to trigger aerosol generation, and the specific manner in which the button is implemented is not significant. For example, other forms of mechanical button or touch-sensitive button (e.g. based on capacitive or optical sensing techniques) may be used in other implementations, or there may be no button and the device may rely on a puff detector for triggering aerosol generation.

The indicator light 22 is provided to give a user with a visual indication of various characteristics associated with the electronic cigarette, for example, an indication of an operating state (e.g. on/off/standby), and other characteristics, such as battery life or fault conditions. Different characteristics may, for example, be indicated through different colors and/or different flash sequences in accordance with generally conventional techniques.

The control circuitry 18 is suitably configured/programmed to control the operation of the electronic cigarette to provide conventional operating functions in line with the established techniques for controlling electronic cigarettes. The control circuitry (processor circuitry) 18 may be considered to logically comprise various sub-units/circuitry elements associated with different aspects of the electronic cigarette's operation. For example, depending on the functionality provided in different implementations, the control circuitry 18 may comprises power supply control circuitry for controlling the supply of power from the battery/power supply to the cartridge in response to user input, user programming circuitry for establishing configuration settings (e.g. user-defined power settings) in response to user input, as well as other functional units/circuitry associated functionality in accordance with the principles described herein and conventional operating aspects of electronic cigarettes, such as indicator light display driving circuitry and user input detection circuitry. It will be appreciated the functionality of the control circuitry 18 can be provided in various different ways, for example using one or more suitably programmed programmable computer(s) and/or one or more suitably configured application-specific integrated circuit(s)/circuitry/chip(s)/chipset(s) configured to provide the desired functionality.

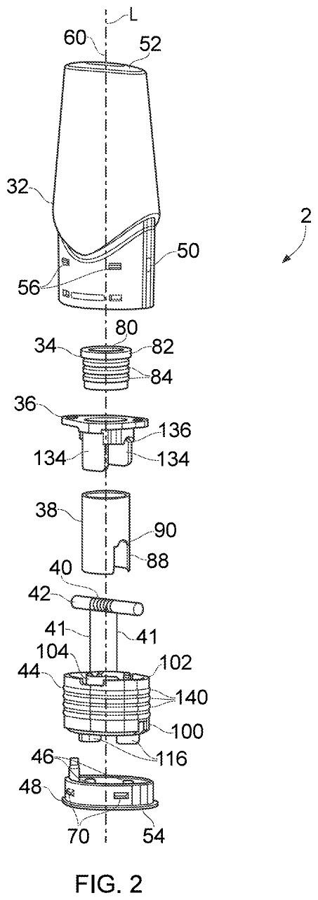

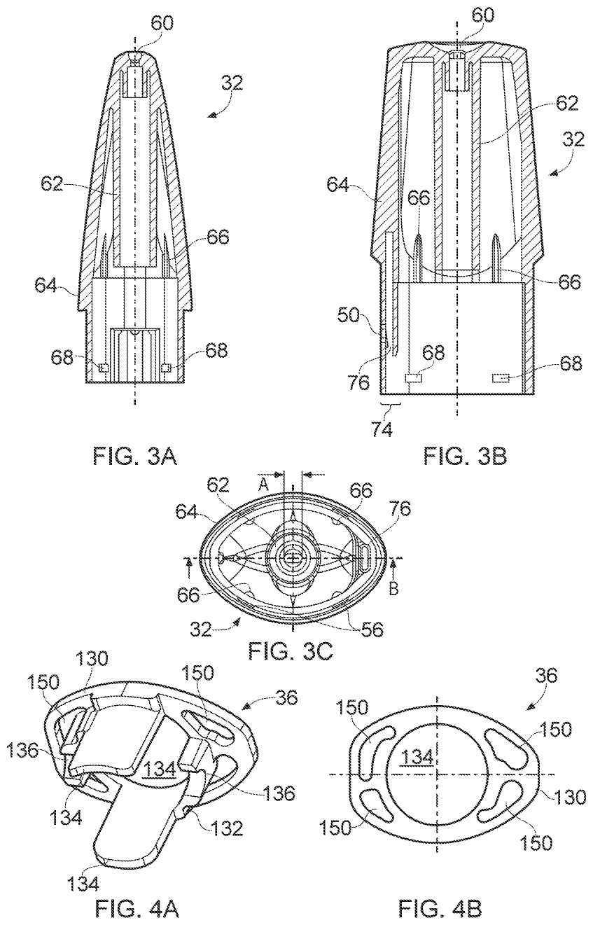

FIG. 2 is an exploded schematic perspective view of the cartridge 2 (exploded along the longitudinal axis L). The cartridge 2 comprises a housing part 32, an air channel seal 34, a dividing wall element 36, an outlet tube 38, a vaporizer/heating element 40, an aerosolizable material transport element 42, a plug 44, and an end cap 48 with contact electrodes 46. FIGS. 3 to 6 schematically represents some of these components in more detail.

FIG. 3A is a schematic cut-away view of the housing part 32 through the longitudinal axis L where the housing part 32 is thinnest. FIG. 3B is a schematic cut-away view of the housing part 32 through the longitudinal axis L where the housing part 32 is widest. FIG. 3C is a schematic view of the housing part along the longitudinal axis L from the interface end 54 (i.e. viewed from below in the orientation of FIGS. 3A and 3B).

FIG. 4A is a schematic perspective view of the dividing wall element 36 as seen from below. FIG. 4B is a schematic cross-section through an upper part of the dividing wall element 36 as viewed from below.

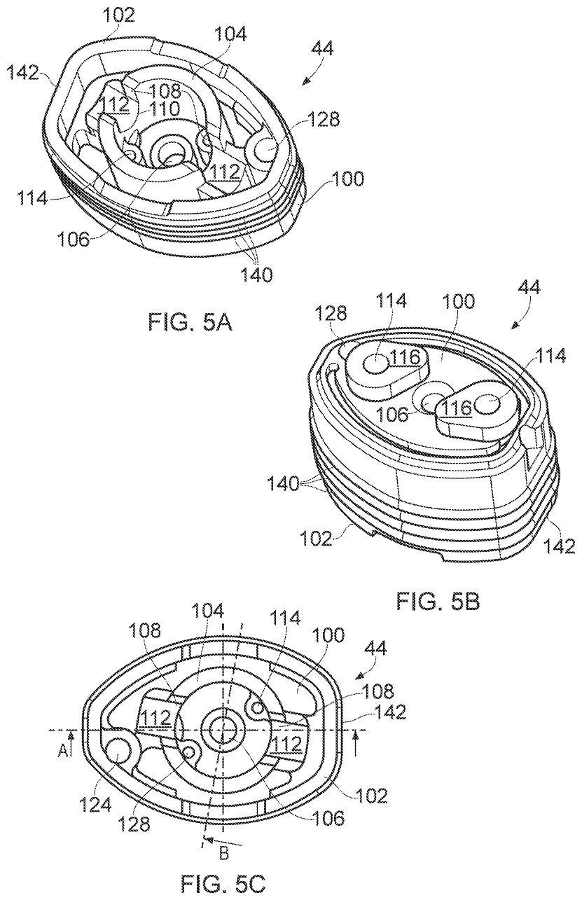

FIG. 5A is a schematic perspective view of the plug 44 from above and FIG. 5B is a schematic perspective view of the plug 44 from below. FIG. 5C is a schematic view of the plug 44 along the longitudinal axis L seen from the mouthpiece end 52 of the cartridge (i.e. viewed from above for the orientation in FIGS. 1 and 2).

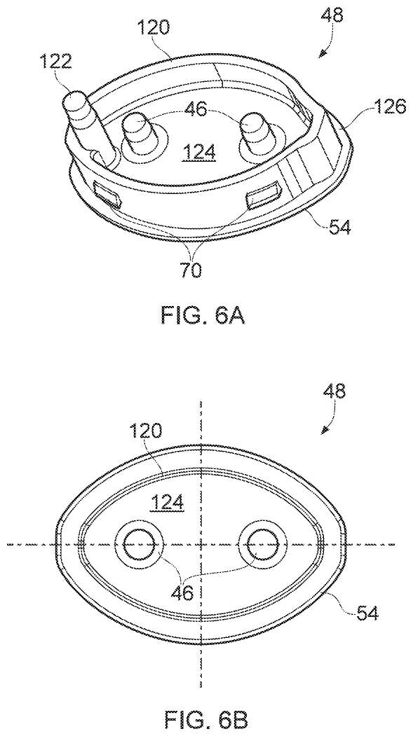

FIG. 6A is a schematic perspective view of the end cap 48 from above. FIG. 6B is a schematic view of the end cap 48 along the longitudinal axis L seen from the mouthpiece end 52 of the cartridge (i.e. from above).

The housing part 32 in this example comprises a housing outer wall 64 and a housing inner tube 62 which in this example are formed from a single molding of polypropylene. The housing outer wall 64 defines the external appearance of the cartridge 2 and the housing inner tube 62 defines a part the air channel through the cartridge. The housing part is open at the interface end 54 of the cartridge and closed at the mouthpiece end 52 of the cartridge except for a mouthpiece opening/aerosol outlet 60 in fluid communication with the housing inner tube 62. The housing part 32 includes an opening in a sidewall which provides the air inlet 50 for the cartridge. The air inlet 50 in this example has an area of around 2 mm². The outer surface of the outer wall 64 of the housing part 32 includes the protrusions 56 discussed above which engage with corresponding detents in the interior surface of the receptacle wall 12 defining the receptacle 8 to provide a releasable mechanical engagement between the cartridge and the aerosol provision device. The inner surface of the outer wall 64 of the housing part includes further protrusions 66 which act to provide an abutment stop for locating the dividing wall element 36 along the longitudinal axis L when the cartridge is assembled. The outer wall 64 of the housing part 32 further comprises holes which provide latch recesses 68 arranged to receive corresponding latch projections 70 in the end cap to fix the end cap to be housing part when the cartridge is assembled.

The outer wall 64 of the housing part 32 includes a double-walled section 74 that defines a gap 76 in fluid communication with the air inlet 50. The gap 76 provides a portion of the air channel through the cartridge. In this example the doubled-walled section 74 of the housing part 32 is arranged so the gap defines an air channel running within the housing outer wall 64 parallel to the longitudinal axis with a cross-section in a plane perpendicular to the longitudinal axis of around 3 mm². The gap/portion of air channel 76 defined by the double-walled section of the housing part extends down to the open end of the housing part 32.

The air channel seal 34 is a silicone moulding generally in the form of a tube having a through hole 80. The outer wall of the air channel seal 34 includes circumferential ridges 84 and an upper collar 82. The inner wall of the air channel seal 34 also includes circumferential ridges, but these are not visible in FIG. 2. When the cartridge is assembled the air channel seal 34 is mounted to the housing inner tube 62 with an end of the housing inner tube 62 extending partly into the through hole 80 of the air channel seal 34. The through hole 80 in the air channel seal has a diameter of around 5.8 mm in its relaxed state whereas the end of the housing inner tube 62 has a diameter of around 6.2 mm so that a seal is formed when the air channel seal 34 is stretched to accommodate the housing inner tube 62. This seal is facilitated by the ridges on the inner surface of the air channel seal 34.

The outlet tube 38 comprises a tubular section, for instance made of ANSI 304 stainless steel or polypropylene, with an internal diameter of around 8.6 mm and a wall thickness of around 0.2 mm. The bottom end of the outlet tube 38 includes a pair of diametrically opposing slots 88 with an end of each slot having a semi-circular recess 90. When the cartridge is assembled the outlet tube 38 mounts to the outer surface of the air channel seal 34. The outer diameter of the air channel seal is around 9.0 mm in its relaxed state so that a seal is formed when the air channel seal 34 is compressed to fit inside the outlet tube 38. This seal is facilitated by the ridges 84 on the outer surface of the air channel seal 34. The collar 80 on the air channel seal 34 provides a stop for the outlet tube 38.

The aerosolisable material transport element 42 comprises a capillary wick and the vaporiser (aerosol generator) 40 comprises a resistance wire heater wound around the capillary wick. In addition to the portion of the resistance wire wound around the capillary wick, the vaporiser comprises electrical leads 41 which pass through holes in the plug 44 to contact electrodes 46 mounted to the end cap 54 to allow power to be supplied to the vaporiser via the electrical interface the established when the cartridge is connected to an aerosol provision device. The vaporiser leads 41 may comprise the same material as the resistance wire wound around the capillary wick, or may comprise a different material (e.g. lower-resistance material) connected to the resistance wire wound around the capillary wick. In this example the heater coil 40 comprises a nickel iron alloy wire and the wick 42 comprises a glass fibre bundle. The vaporiser and aerosolisable material transport element may be provided in accordance with any conventional techniques and is may comprise different forms and/or different materials. For example, in some implementations the wick may comprise fibrous or solid a ceramic material and the heater may comprise a different alloy. In other examples the heater and wick may be combined, for example in the form of a porous and a resistive material. More generally, it will be appreciated the specific nature aerosolisable material transport element and vaporiser is not of primary significance to the principles described herein.

When the cartridge is assembled, the wick 42 is received in the semi-circular recesses 90 of the outlet tube 38 so that a central portion of the wick about which the heating coil is would is inside the outlet tube while end portions of the wick are outside the outlet tube 38. The plug 44 in this example comprises a single moulding of silicone, may be resilient.

The plug comprises a base part 100 with an outer wall 102 extending upwardly therefrom (i.e. towards the mouthpiece end of the cartridge). The plug further comprises an inner wall 104 extending upwardly from the base part 100 and surrounding a through hole 106 through the base part 100.

The outer wall 102 of the plug 44 conforms to an inner surface of the housing part 32 so that when the cartridge is assembled the plug in 44 forms a seal with the housing part 32. The inner wall 104 of the plug 44 conforms to an inner surface of the outlet tube 38 so that when the cartridge is assembled the plug 44 also forms a seal with the outlet tube 38. The inner wall 104 includes a pair of diametrically opposing slots 108 with the end of each slot having a semi-circular recess 110. Extended outwardly (i.e. in a direction away from the longitudinal axis of the cartridge) from the bottom of each slot in the inner wall 104 is a cradle section 112 shaped to receive a section of the aerosolisable material transport element 42 when the cartridge is assembled. The slots 108 and semi-circular recesses 110 provided by the inner wall of the plug 44 and the slots 88 and semi-circular recesses 90 of the outlet tube 38 are aligned so that the slots 88 in the outlet tube 38 accommodate respective ones of the cradles 112 with the respective semi-circular recesses in the outlet tube and plug cooperating to define holes through which the aerosolisable material transport element passes. The size of the holes provided by the semi-circular recesses through which the aerosolisable material transport element passes correspond closely to the size and shape of the aerosolisable material transport element, but are slightly smaller so a degree of compression is provided by the resilience of the plug 44. This allows aerosolisable material to be transported along the aerosolisable material transport element by capillary action while restricting the extent to which aerosolisable material which is not transported by capillary action can pass through the openings. As noted above, the plug 44 includes further openings 114 in the base part 100 through which the contact leads 41 for the vaporiser pass when the cartridge is assembled. The bottom of the base part of the plug includes spacers 116 which maintain an offset between the remaining surface of the bottom of the base part and the end cap 48. These spacers 116 include the openings 114 through which the electrical contact leads 41 for the vaporiser pass.

The end cap 48 comprises a polypropylene moulding with a pair of gold-plated copper electrode posts 46 mounted therein.

The ends of the electrode posts 44 on the bottom side of the end cap are close to flush with the interface end 54 of the cartridge provided by the end cap 48. These are the parts of the electrodes to which correspondingly aligned sprung contacts in the aerosol provision device 4 connect when the cartridge 2 is assembled and connected to the aerosol provision device 4. The ends of the electrode posts on the inside of the cartridge extend away from the end cap 48 and into the holes 114 in the plug 44 through which the contact leads 41 pass. The electrode posts are slightly oversized relative to the holes 114 and include a chamfer at their upper ends to facilitate insertion into the holes 114 in the plug where they are maintained in pressed contact with the contact leads for the vaporiser by virtue of the plug.

The end cap has a base section 124 and an upstanding wall 120 which conforms to the inner surface of the housing part 32. The upstanding wall 120 of the end cap 48 is inserted into the housing part 32 so the latch projections 70 engage with the latch recesses 68 in the housing part 32 to snap-fit the end cap 48 to the housing part when the cartridge is assembled. The top of the upstanding wall 120 of the end cap 48 abuts a peripheral part of the plug 44 and the lower face of the spacers 116 on the plug also abut the base section 124 of the plug so that when the end cap 48 is attached to the housing part it presses against the resilient part 44 to maintain it in slight compression.

The base portion 124 of the end cap 48 includes a peripheral lip 126 beyond the base of the upstanding wall 112 with a thickness which corresponds with the thickness of the outer wall of the housing part at the interface end of the cartridge. The end cap also includes an upstanding locating pin 122 which aligns with a corresponding locating hole 128 in the plug to help establish their relative location during assembly.

The dividing wall element 36 comprises a single moulding of polypropylene and includes a dividing wall 130 and a collar 132 formed by projections from the dividing wall 130 in the direction towards the interface end of the cartridge. The dividing wall element 36 has a central opening 134 through which the outlet tube 38 passes (i.e. the dividing wall is arranged around the outlet tube 38). In some embodiments, the dividing wall element 36 may be integrally formed with the outlet tube 38. When the cartridge is assembled, the upper surface of the outer wall 102 of the plug 44 engages with the lower surface of the dividing wall 130, and the upper surface of the dividing wall 130 in turn engages with the projections 66 on the inner surface of the outer wall 64 of the housing part 32. Thus, the dividing wall 130 prevents the plug from being pushed too far into the housing part 32—i.e. the dividing wall 130 is fixedly located along the longitudinal axis of the cartridge by the protrusions 66 in the housing part and so provides the plug with a fixed surface to push against. The collar 132 formed by projections from the dividing wall includes a first pair of opposing projections/tongues 134 which engage with corresponding recesses on an inner surface of the outer wall 102 of the plug 44. The protrusions from the dividing wall 130 further provide a pair of cradle sections 136 configured to engage with corresponding ones of the cradle sections 112 in the part 44 when the cartridge is assembled to further define the opening through which the aerosolisable material transport element passes.

When the cartridge 2 is assembled an air channel extending from the air inlet 50 to the aerosol outlet 60 through the cartridge is formed. Starting from the air inlet 50 in the side wall of the housing part 32, a first section of the air channel is provided by the gap 76 formed by the double-walled section 74 in the outer wall 64 of the housing part 32 and extends from the air inlet 50 towards the interface end 54 of the cartridge and past the plug 44. A second portion of the air channel is provided by the gap between the base of the plug 44 and the end cap 48. A third portion of the air channel is provided by the hole 106 through the plug 44. A fourth portion of the air channel is provided by the region within the inner wall 104 of the plug and the outlet tube around the vaporiser 40. This fourth portion of the air channel may also be referred to as an aerosol/aerosol generation region, it being the primary region in which aerosol is generated during use. The air channel from the air inlet 50 to the aerosol generation region may be referred to as an air inlet section of the air channel. A fifth portion of the air channel is provided by the remainder of the outlet tube 38. A sixth portion of the air channel is provided by the outer housing inner tube 62 which connects the air channel to the aerosol outlet 60. The air channel from the aerosol generation region to be the aerosol outlet may be referred to as an aerosol outlet section of the air channel.

Also, when the cartridge is assembled a reservoir 31 for aerosolisable material is formed by the space outside the air channel and inside the housing part 32. This may be filled during manufacture, for example through a filling hole which is then sealed, or by other means. The specific nature of the aerosolisable material, for example in terms of its composition, is not of primary significance to the principles described herein, and in general any conventional aerosolisable material of the type normally used in electronic cigarettes may be used. The present disclosure may refer to a liquid as the aerosolisable material, which as mentioned above may be a conventional e-liquid. However, the principles of the present disclosure apply to any aerosolisable material which has the ability to flow, and may include a liquid, a gel, or a solid, where for a solid a plurality of solid particles may be considered to have the ability to flow when considered as a bulk.

The reservoir is closed at the interface end of the cartridge by the plug 44. The reservoir includes a first region above the dividing wall 130 and a second region below the dividing wall 130 within the space formed between the air channel and the outer wall of the plug. The aerosolisable material transport element (capillary wick) 42 passes through openings in the wall of the air channel provided by the semi-circular recesses 108, 90 in the plug 44 and the outlet tube 38 and the cradle sections 112, 136 in the plug 44 and the dividing wall element 36 that engage with one another as discussed above. Thus, the ends of the aerosolisable material transport element extend into the second region of the reservoir from which they draw aerosolisable material through the openings in the air channel to the vaporiser 40 for subsequent vaporisation.

In normal use, the cartridge 2 is coupled to the aerosol provision device 4 and the aerosol provision device activated to supply power to the cartridge via the contact electrodes 46 in the end cap 48. Power then passes through the connection leads 41 to the vaporiser 40. The vaporiser is thus electrically heated and so vaporises a portion of the aerosolisable material from the aerosolisable material transport element in the vicinity of the vaporiser. This generates aerosol in the aerosol generation region of the air path. Aerosolisable material that is vaporised from the aerosolisable material transport element is replaced by more aerosolisable material drawn from the reservoir by capillary action. While the vaporiser is activated, a user inhales on the mouthpiece end 52 of the cartridge. This causes air to be drawn through whichever aerosol provision device air inlet 14 aligns with the air inlet 50 of the cartridge (which will depend on the orientation in which the cartridge was inserted into the aerosol provision device receptacle 8). Air then enters the cartridge through the air inlet 50, passes along the gap 76 in the double-walled section 74 of the housing part 32, passes between the plug 44 and the end cap 48 before entering the aerosol generation region surrounding the vaporiser 40 through the hole 106 in the base part 100 of the plug 44. The incoming air mixes with aerosol generated from the vaporiser to form a condensation aerosol, which is then drawn along the outlet tube 38 and the housing part inner 62 before exiting through the mouthpiece outlet/aerosol outlet 60 for user inhalation.

From the above FIGS. 1-6B, it can be seen a possible embodiment construction of aerosol provision system 1 which is configured for generating an aerosol, which is suitable for use in the context of the present disclosure (alongside potentially other forms of aerosol provision system).

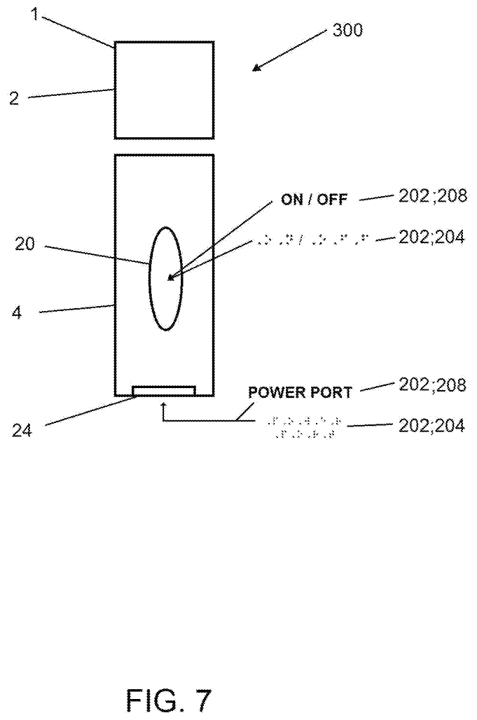

Turning now to FIGS. 7-10, the present disclosure also provides for an aerosol provision system 300 comprising a tactile indicator 200 for providing an indication 202, such as a tactile indication, of an operation or characteristic of the aerosol provision system 1. In this way, and at a general level, the presence of the tactile indicator 200 may therefore make it easier for a user to discern a particular operation or characteristic of the aerosol provision system 1, in a way that does not necessarily require any visual inspection of the aerosol provision system 1. Thus, and particularly for visually impaired users of the aerosol provision system 1, the introduction of the tactile indicator 200 may help to increase the operability/usability of the aerosol provision system 1, to thus provide the (revised) aerosol provision system 300.

At a general level, it is envisaged in accordance with some embodiments that the tactile indicator 200 may be either an electrically operated tactile indicator 200, which is configured to receive signals from the aerosol provision system, or in some narrower embodiments from the aerosol provision device. Equally, in accordance with some other embodiments, it is envisaged that the tactile indicator 200 may be non-electrical, such that the tactile indicator 200 is configured to be mechanically operated and/or configured to remain stationary, or be static, in use. Broadly, the tactile indicator 200 may be of a type that is capable of actively changing the indication that it outputs, e.g., via electrical or mechanical manipulation, and thus may be referred to as an ‘active’ tactile indicator, or the tactile indicator 200 may be of a type that is capable of outputting a static indication that is not capable of being changed, and thus may be referred to as a ‘static’ tactile indicator.

Noting the above therefore, and with reference to the embodiment shown in FIG. 7, in accordance with some embodiments, the tactile indicator 200 may be configured to provide an indication 202 comprising the location of an actuator from the aerosol provision system 1. It will be appreciated the actuator in this instance could be a variety of different components from the aerosol provision system 1, such as (and certainly not limited to) the input button 20 (as shown for instance in the embodiment of FIG. 7) or some other switch or actuatable portion from the aerosol provision system 1 which is configured to control the operation of the aerosol provision system 1. In some implementations, the tactile indicator 200 may be provided at the same, or substantially the same, location as the actuator to help identify the location of the actuator to a user.

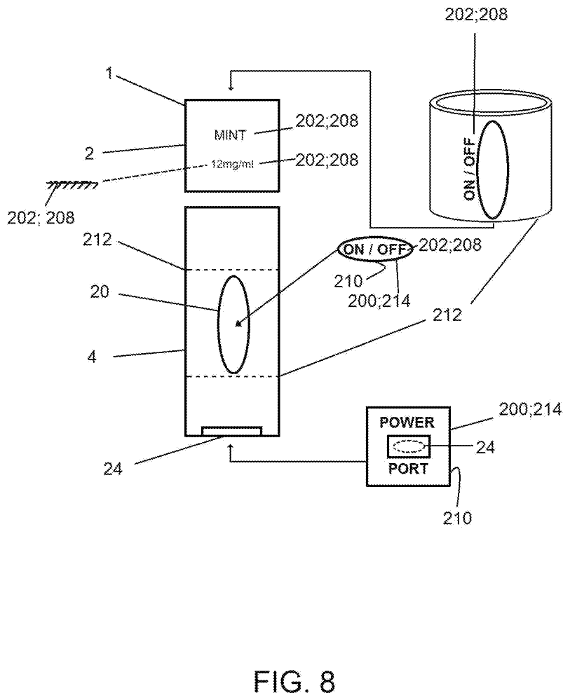

Equally, in accordance with some embodiments where the aerosol provision system 1 comprises an electrical connection port, such as the charging port 24, for delivering power to the aerosol provision system 1, in accordance with some of these embodiments, the indication 202 from the tactile indicator 200 may comprise the location of the electrical connection port (as shown for instance in the embodiment of FIG. 7). In some implementations, the tactile indicator 200 may be provided at the same, or substantially the same, location as the electrical connection port to help identify the location of the electrical connection port to a user.

Where such a tactile indicator 200 is present, in accordance with some embodiments, such as that shown in FIG. 7, the tactile indicator 200 may be configured to display an indication 202 in Braille 204. In this respect as well, it will be appreciated that the tactile indicator 200 may be configured to provide the indication in the form of at least one or more projections and/or one or more recesses which together function to provide the indication 202 (e.g. the Braille dots 204 being provided as a plurality of projections which can be felt in a tactile manner by the user of the aerosol provision system 1). For completeness however, where such one or more projections and/or recesses are employed, it will be appreciated that they need not necessarily be configured to display an indication in Braille. For instance, additionally/alternatively the tactile indicator 200 may be configured to provide a tactile indication (using the projection(s) and/or recess(es)) in any language, such as English or French, or be configured to provide an indication 202 comprising one or more graphical symbols 206 (e.g. a power plug symbol, or lightening bolt symbol). This is shown, for instance, with reference to the embodiment from FIG. 7, where the indication 202 comprises raised or recessed text 208 on a surface of the aerosol provision system 1, such as a surface of, or a surface surrounding, the charging port 24; and/or a surface of, or a surface surrounding, the input button 20. As will also be described, such use of the projections can also be seen in the embodiment of FIG. 8.

Appreciating the above, with respect to the physical location of the tactile indicator 200, it is envisaged in some embodiments that the tactile indicator 200 may be located on a surface, such as an external surface of the aerosol provision system 1, e.g. as shown in the embodiment of FIG. 7.

In accordance with some embodiments however, which may facilitate the retrofitting of existing aerosol provision systems 1 which do not employ a tactile indicator 200, the tactile indicator 200 may comprise an attachment means, such as an adhesive surface 210 or fastening mechanism (e.g. in the form of a gripping sleeve 212), for attaching the tactile indicator 200 to the aerosol provision system 1. In accordance with such embodiments, the attachment means may be configured to provide a temporary/releasable attaching, or may be configured to provide a permanent attaching. For instance, for illustration purposes, FIG. 8 shows an embodiment of aerosol provision system 300 where the tactical indicator 200 is releasably attachable to the aerosol provision system 1, such as by way of its attachment means comprising a sticker 214 which is attachable to the aerosol provision system 1 (e.g. on or around the input button 20, or attachable to the aerosol provision system 1 around the electrical connection port). FIG. 8 also illustrates potential other embodiments for the tactile indicator 200, where the attachment means comprises a sleeve 212 which is attachable around a portion of the aerosol provision system 1 (such as around a portion of the cartridge 2 or a portion of the aerosol provision device 4). Where such a sleeve 212 is thus employed, in accordance with some embodiments the sleeve 212 may be configured to engage with the aerosol provision system 1 by a friction fit or interference fit. Equally, in accordance with some embodiments, the sleeve 212 may be configured to be elasticated or resiliently deformable for engaging with the aerosol provision system 1.

Appreciating the above therefore, it may be seen that such embodiments allow for the provision of a tactile indicator 200 for providing an indication 202 of an operation or characteristic of an aerosol provision system 1, wherein the tactile indicator 200 is configured to be attached to an aerosol provision system 1; and wherein the tactile indicator 200 comprises an attachment means, such as an adhesive surface 210, for attaching the tactile indicator 200 to the aerosol provision system 1.

Equally, the above disclosure thus also provides for a method of retrofitting an aerosol provision system 300, comprising an aerosol provision system 1 for generating an aerosol, wherein the method comprises: attaching a tactile indicator 200, for providing an indication of an operation or characteristic of the aerosol provision system 1, to the aerosol provision system 1. In this way for instance, in accordance with some embodiments therefore, the method may then appreciably comprise attaching the tactile indicator 200 to the aerosol provision system 1 via an attachment means or attachment mechanism, such as an adhesive surface 210, from the tactile indicator 200.

The above disclosures thus effectively allow for many existing aerosol provision devices 1, which may not as well suited for those with visual impairments, to be improved upon to facilitate operation thereof for users with such visual impairments.

Appreciating the above disclosure, it is to be noted for completeness that any employed tactile indicator 200 may be used in the context of either single component aerosol provision systems 1, and/or aerosol provision systems 1 which comprise a cartridge 2 and/or an aerosol provision device 4 (as shown for instance in the embodiments of FIGS. 7-10). That being the case, it will be appreciated that depending on the intended indication 202 which the tactile indicator 200 is configured to provide, the tactile indicator 200 may in accordance with some embodiments be located on, such as surface of, or an external surface of, the cartridge 2 and/or the aerosol provision device 4. Or, phrased in a slightly different way, in accordance with some embodiments, the aerosol provision device 4 may comprise the tactile indicator 200, and/or the cartridge 2 may comprise the tactile indicator 200 in accordance with some embodiments.

Tying in with the above, it will be appreciated that depending on the intended indication 202 which the tactile indicator 200 is configured to provide, the indication 202 may comprise an operation or characteristic of the cartridge 2. Purely for illustrative examples, the indication 202 in accordance with some particular embodiments may comprise any combination of: an indication of a remaining amount of aerosolisable material located in the cartridge; an indication that the cartridge is received by the aerosol provision device; an indication of the size of the cartridge, an indication of a volumetric capacity of aerosolisable material in the cartridge; an indication of the flavour of the aerosolisable material from the cartridge 2 (where the aerosolisable material is flavoured); and/or an indication of the concentration of the aerosolisable material from the cartridge 2 (e.g. in mg/ml, for instance as per the exemplary embodiment from FIG. 8). Again, for completeness, any tactile indication 202 in accordance with some of these embodiments, as required, may comprise one or more projections and/or recesses to provide the tactility of the indicator 200, again as illustrated in the particular embodiment of FIG. 8, where an indication 202 of the concentration of the aerosolisable material from the cartridge 2 is provided via raised/protruding text 208 on a surface of the cartridge 2.

Equally, in accordance with some embodiments where such a cartridge 2 and aerosol provision device 4 operation is employed, the indication 202 may comprise an operation or characteristic of the aerosol provision device 4. Purely by way of example, and in accordance with some embodiments, the indication 202 may comprise an indication 202 that the cartridge 2 is received by the aerosol provision device 4, an indication of the size of the size or charge capacity of any provided power source, such as a battery 18, from the aerosol provision device 4; and/or an indication that any provided power source from the aerosol provision device 4 comprises less than a predetermined amount of stored energy.

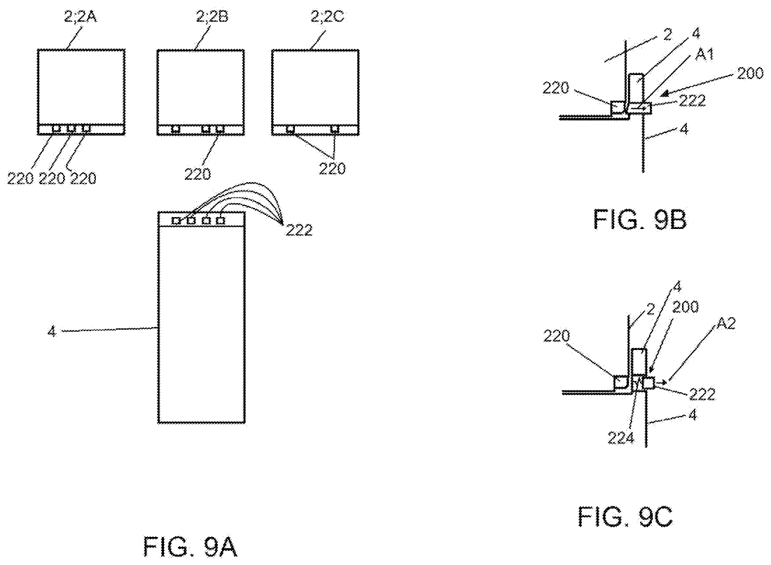

In accordance with some embodiments here described, such as those shown in the embodiments of FIG. 9A-9C, it is also contemplated that the tactile indicator 200 may be configured to change from a first shape (or first configuration, more generally) to a second shape (or second configuration, more generally) for providing the indication 202. In this way, for instance, the tactile indicator 200 may be configured to provide an indication when a particular operation of the aerosol provision system 1 has occurred. For example, in accordance with some embodiments where a cartridge 2 and aerosol provision device 4 arrangement is employed, such as that shown in the embodiments of FIGS. 9A-9C, the tactile indicator 200 may be configured to adopt a first shape or configuration when the cartridge 2 is not received by the aerosol provision device 4, and be configured to adopt a second shape or configuration, which is different from the first shape or configuration, when the cartridge 2 is received by the aerosol provision device 4. It will be appreciated that the exact shape or configuration of the first and second shapes/configurations may be selected so as to be suitably distinguishing from each other. Similarly, it will be appreciated that this change in shape/configuration may be effected mechanically, magnetically, or even electrically. For instance, two example embodiments for effecting of the change in shape/configuration of the tactile indicator 200 can respectively be seen with reference to the embodiments illustrated in FIGS. 9B and 9C.

In accordance with such embodiments for instance, one of the cartridge 2 and the aerosol provision device 4 may comprise at least one (and/or more than one, in some narrower embodiments) first engagement member 220, which is configured to engage and/or move a corresponding at least one (and/or more than one, in some narrower embodiments) second engagement member 222 from the other of the cartridge 2 and the aerosol provision device 4, when the cartridge 2 is received by the aerosol provision device 4. In this way, as a result of this engagement or movement from the tactile indicator 200 when the cartridge 2 is received by the aerosol provision device 4, the user may be able to discern this in a tactile manner, to thus discern when the cartridge 2 is received by the aerosol provision device 4.

In accordance with some narrower embodiments, such as those where a mechanical effecting is implemented, the at least one first engagement member 220 may comprise at least one first protrusion, and the least one second engagement member 222 may comprise at least one second projection or second recess, as shown with reference to the embodiment from FIG. 9A and 9B. In this way, when the cartridge 2 is received by the aerosol provision device 4, the engagement of the at least one first engagement member 220 with the at least one second engagement member 222, resulting in a change in shape/configuration of the tactile indicator 200 (as notified by the arrow A1 in the first, upper, embodiment of FIG. 9) may thus allow the user discern when the cartridge 2 is received by the aerosol provision device 4.

Equally, in accordance with some embodiments, a similar change in shape/configuration from the first shape/configuration to the second shape/configuration may be effected magnetically, as shown in the particular embodiment from FIG. 9A and 9C. In accordance with such embodiments, the at least one first engagement member 220 may comprise at least one first magnetic member, and the at least one second engagement member 222 may comprise at least one first magnetic member which is configured to be magnetically repelled by the at least one first engagement member 220 when the cartridge 2 is received by the aerosol provision device 4. In this way, when the cartridge 2 is received by the aerosol provision device 4, the at least one first engagement member 220 may induce a magnetic force on the at least one second engagement member 222, resulting in a change in shape/configuration of the tactile indicator 200 (as notified by the arrow A2 in the embodiment of FIGS. 9A and 9C) to thus allow the user discern when the cartridge 2 is received by the aerosol provision device 4.

In accordance with some particular embodiments to those described above, the tactile indicator 200 may comprise at least one biasing member 224 or biasing means, such as a spring or a resilient member, for reverting the tactile indicator 200 back to the first shape/configuration, e.g. as shown with reference the spring in the embodiment illustrated in FIGS. 9A and 9C. In this way for instance, and in accordance with some particular embodiments where the cartridge 2 and aerosol provision device 4 arrangement is employed, the biasing member or biasing means may be useable for reverting the tactile indicator 200 back to the first shape or configuration when the aerosol provision device 4 no longer receives the cartridge 2, as shown in the embodiment illustrated in FIGS. 9A and 9C.

Staying with any provided at least one (or a plurality) of first and second engagement members 220;222, where these are employed, in accordance with some particular embodiments, it will be appreciated that these could provide for at least one embodiment of tactile indicator 200 which can be configured to adopt a third shape or configuration, which is different from the first shape or configuration and the second shape or configuration, when a second cartridge 2B (which is different from a first cartridge 2A) is received by the aerosol provision device 4. In this way, the tactile indicator 200 can thus serve to provide a user with an indication 202 as to whether a cartridge 2 is received by the aerosol provision device 4, and if so what particular type of cartridge 2 is received by the aerosol provision device 4. Such an operation is disclosed with reference to the different cartridges 2A;2B;2C from the embodiment disclosed in FIG. 9A, which each have a different combination/arrangement of first engagement members 220.

Purely by way of example, the embodiments from FIGS. 9A-9C illustrate how such functionality of the tactile indicator 200 to change between different shapes or configurations in use may be achieved. In this respect, it is noted that these embodiments from FIGS. 9A-9C each employ a plurality of engagement members 220, such that the first cartridge 2A comprises a first configuration of engagement members 220, and such that the second cartridge 2B comprises a second configuration of engagement members 220 which is different from the first configuration of engagement members 220. In this way therefore, by selecting the configuration of the engagement members to be different for each cartridge 2A;2B;2C, the tactile indicator 200 can thus serve to provide a user with an indication 202 as to a) whether a cartridge 2 is received by the aerosol provision device 4, and b) if so what particular type of cartridge 2A;2B;2C is received by the aerosol provision device 4 (e.g. by seeing which of the second engagement members 222, in the case of the embodiments from FIG. 9A-9C, are engaged when the cartridge 2 is received by the aerosol provision device 4.

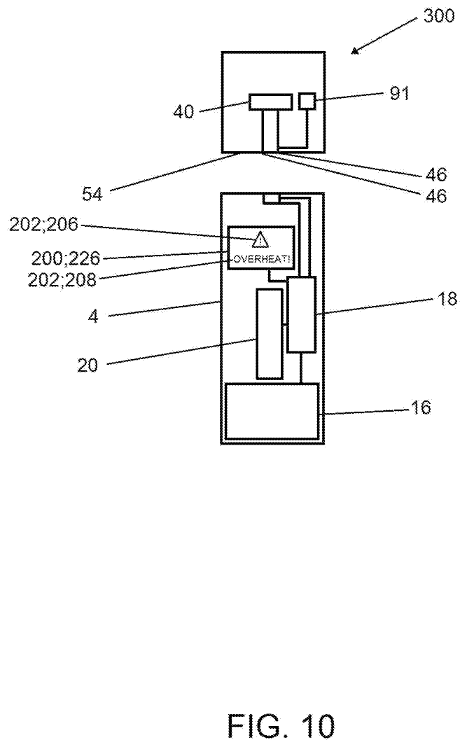

Purely for completeness therefore, it will be appreciated that in such embodiments where the tactile indicator 200 is configured to change between different shapes or configurations in use, it will be appreciated that the provision of engagement members 220;222 need not necessarily be provided. Indeed, more generally speaking, the present disclosure also provides for any form of tactile indicator 200 which may change between different shapes or configurations in use. Indeed, a particular embodiment of tactile indicator 200 may comprise a tactile display 226, which can display otherwise graphical information in a tactile manner (e.g. by way a display having an array of individual projections which can be separately raised/recessed—and which each form a pixel of the tactile display 226). An example of such a tactile display 226, which may in accordance with some embodiments be in particular a refreshable tactile display (i.e. one whose content may be refreshed/changed in use), is a refreshable braille display. Such a (refreshable) tactile display 226 is illustrated in FIG. 10, whose content will now be described in further detail.

With reference to the disclosure from FIG. 10, there is provided in accordance with some embodiments of the present disclosure, a tactile indicator 200 which may be electrically operated. Put differently, the aerosol provision system 300 in accordance with such embodiments may be configured generate a first signal, in response to determining that a first predetermined criterion is satisfied; and send the first signal to the tactile indicator 200. In this way therefore, the tactile indicator 200 in accordance with at least some of these embodiments may be then configured, in response to receiving the first signal, to change from a first shape or configuration to a second shape or configuration, for providing the indication 202 to the user.

Depending on the aerosol provision system 300 employed, it will be appreciated that the predetermined criterion could be a variety of different criterion.

In this respect for instance, and in accordance with some embodiments, the first predetermined criterion may comprise the aerosol provision system 1 being switched on. In this way therefore, the indication 202 provided by the tactile indicator 200 may then comprise an indication that the aerosol provision system 1 is switched on.

Similarly, in accordance with some additional/alternative embodiments, the first predetermined criterion may comprise the cartridge 2 being received by the aerosol provision device 4 (where such a cartridge 2/aerosol provision device 4 type aerosol provision system 1 is employed). In this way therefore, the indication 202 provided by the tactile indicator 200 may then comprise an indication 202 that the cartridge 2 is received by the aerosol provision device 4.

Equally, in accordance with some additional/alternative embodiments, in so far as the aerosol provision system 1 further comprises a vaporiser 40 for vaporising the aerosolisable material, the first predetermined criterion may comprise the vaporiser 40 being operated. In this way therefore, the indication 202 may comprise an indication that the vaporiser 40 is being operated.

In accordance with some yet additional/alternative embodiments, and again in so far as the aerosol provision system 1 further comprises a vaporiser 40 for vaporising the aerosolisable material, the first predetermined criterion may comprise the vaporiser 40 exceeding a predetermined temperature. In this way therefore, the indication provided by the tactile indicator 200 may then comprise an indication 202 that the vaporiser 40 has overheated. Purely by way of illustration, this may be seen in accordance with the embodiment from the FIG. 10, where the tactile indicator 200 in the form of a tactile display 226 provides an indication 202 comprising a tactile symbol 206, and/or a tactile text 208, for providing the indication 202 that the vaporiser 40 has overheated.

Staying with the above embodiments, it will be appreciated that in some narrower embodiments thereof, in addition to making any determinations as to whether any first predetermined criterion may be satisfied, the aerosol provision system may be further configured to: generate a second signal, in response to determining that a second predetermined criterion is satisfied; and send the second signal to the tactile indicator 200. In this way, the tactile indicator 200 may be then configured to adopt a third shape (or configuration) in response to the tactile indicator 200 receiving the second signal, wherein the third shape (configuration) is different from the first shape (configuration) and the second shape (configuration). Appreciably therefore, by being able to (separately) determine whether either a first or a second predetermined criterion is satisfied, which for instance could each be any of the (non-exhaustive) criterion described previously, the tactile indicator 200 may be configured to react to different events occurring in the aerosol provision system 300 at any given time(s).

In so far as any given signal(s) may be generated in the aerosol provision system 300, as noted above, it will be appreciated that each such signal may be generated in an appropriate way, depending on the predetermined criterion which is associated with the signal. In accordance with some particularly convenient embodiments, where the aerosol provision system 1 comprises the control circuity 18, the control circuitry 18 may be configured for determining whether the predetermined criterion is satisfied, and/or may be configured to generate the relevant signal in the event that this predetermined criterion is satisfied.

Equally, to facilitate any determination of a given predetermined criterion being satisfied, the control circuitry 18 may be configured to receive sensor data from the aerosol provision system 1, and be configured to process the sensor data to determine whether the predetermined criterion is satisfied. For instance, in embodiments where the predetermined criterion comprises the vaporiser 40 exceeding a predetermined temperature, the control circuitry 18 may be configured to receive sensor data from a temperature sensor 91 from the aerosol provision system 1. Equally, where the indication 202 comprises an indication 202 on whether the aerosol provision system 1 is switched on, the control circuitry 18 may be in electrical communication with the power source (such as the battery 16) and/or the input button 20 to facilitate making a determination that the aerosol provision system 1 is switched on.

With reference to the foregoing disclosure therefore, there has accordingly been described a number of different possible implementations for a tactile indicator 200 for use in an aerosol provision system 300. The tactile indicator 200 may be supplied with a given aerosol provision system 1, or may be retrospectively used with, or attached to, such an aerosol provision system 1. The tactile indicator 200 may be electrically operated, or may be mechanically operated and/or configured to remain stationary (or be static) in use. Whatever the implementation however, it may be appreciated the various described embodiments facilitate the operation of an aerosol provision system 1, particularly to those users which have a visual impairment.

Appreciating the foregoing therefore, there has accordingly been described an aerosol provision system comprising:
an aerosol provision device for generating an aerosol; and
a tactile indicator for providing an indication of an operation or characteristic of the aerosol provision system.

There has also been described a cartridge for an aerosol provision system comprising the cartridge and an aerosol provision device, wherein the cartridge comprises:
a tactile indicator for providing an indication of an operation or characteristic of the aerosol provision system.

There has also been described a tactile indicator for providing an indication of an operation or characteristic of an aerosol provision device, wherein the tactile indicator is configured to be attached to an aerosol provision device;
wherein the tactile indicator comprises an adhesive surface for attaching the tactile indicator to the aerosol provision device.

There has also been described an aerosol provision device for generating an aerosol in an aerosol provision system, wherein the aerosol provision device further comprises a tactile indicator for providing an indication of an operation or characteristic of the aerosol provision system

There has also been described a method of providing an indication of an operation or characteristic of an aerosol provision system configured to generate an aerosol, the method comprising:
in response to a first predetermined criterion being satisfied, changing a configuration of the tactile indicator from a first configuration to a second configuration.

There has also been described a method of retrofitting an aerosol provision system, comprising an aerosol provision device for generating an aerosol, wherein the method comprises:
attaching a tactile indicator, for providing an indication of an operation or characteristic of the aerosol provision system, to the aerosol provision system. aerosol provision device

There has also been described a tactile indicator 200 for use in an aerosol provision system 300. The tactile indicator 200 may be supplied with a given aerosol provision system 1, or may be retrospectively used with, or attached to, an aerosol provision device 2. The tactile indicator 200 may be electrically operated, or may be mechanically operated and/or configured to remain stationary in use. The tactile indicator 200 may therefore facilitate the operation of an aerosol provision system 1, particularly to those users which have a visual impairment.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

Purely for completeness, in terms of how any of the sensor(s) 91 or tactile indicator 200 (where this is electrically operated) may be powered (if they are present at all), it will be appreciated that these features may be powered using either the power supply 16 (as shown in the embodiment of FIG. 10), or each powered with its own power source (not shown in the Figures).

Equally, with regard to the positioning of any such sensor(s) and/or the tactile indicator, it will be appreciated that their locations may be provided anywhere in the aerosol provision system 300 as may be required to allow them to provide their required functionality. In the case of the tactile indicator 200, this may even include a location where the tactile indicator 200 is not actually located on the aerosol provision system 1.

Equally, and where the aerosol provision system 1 comprises a cartridge 2 and an aerosol provision device 4, any provided sensor(s) may be located in either the cartridge 2 or the aerosol provision device 4, as needed so as to allow the required functionality of the sensor.

Also in respect of any provided sensor(s) or tactile indicator 200 in the aerosol provision system 1, it will be appreciated that any signal therefrom may be sent using either a wired or wireless connection between the control circuitry 18 and the sensor and/or tactile indicator 200. In the particular embodiment shown in FIG. 10, for instance, a wired connection is provided between the temperature sensor 91 and the control circuitry 18, and which extends in the case of the sensor 91 being located in the cartridge 2 across the interface end 54 and corresponding receptacle 8 between the aerosol provision device 4 and the cartridge 2 via the contact electrodes 46.

1. An aerosol provision system comprising:
an aerosol provision device for generating an aerosol; and
a tactile indicator for providing an indication of an operation or characteristic of the aerosol provision system.

2. An aerosol provision system according to claim 1, wherein the aerosol provision device comprises an actuator for controlling an operation of the aerosol provision device, wherein the indication comprises the location of the actuator.

3. An aerosol provision system according to claim 1, wherein the aerosol provision device comprises an electrical connection port for delivering power to the aerosol provision device, wherein the indication comprises the location of the electrical connection port.

4. An aerosol provision system according to claim 1, wherein the indication comprises an indication on whether the aerosol provision device is switched on.

5. An aerosol provision system according to claim 1, wherein the tactile indicator is configured to change from a first configuration to a second configuration for providing the indication.

6. An aerosol provision system according to any claim 5, wherein the aerosol provision device is configured to:
generate a first signal, in response to determining that a first predetermined criterion is satisfied; and
send the first signal to the tactile indicator;
wherein the tactile indicator is configured to change from the first configuration to the second configuration, for providing the indication, in response to the tactile indicator receiving the first signal.

7. An aerosol provision system according to claim 6, wherein the first predetermined criterion comprises the aerosol provision device being switched on, and wherein the indication comprises an indication that the aerosol provision device is switched on.

8. An aerosol provision system according to claim 6, wherein the aerosol provision system further comprises an aerosol generator for aerosolising aerosol-generating material, wherein the first predetermined criterion comprises the aerosol generator being operated, and wherein the indication comprises an indication that the aerosol generator is being operated.

9. An aerosol provision system according to claim 6, wherein the aerosol provision system further comprises an aerosol generator for aerosolising aerosol-generating material, wherein the first predetermined criterion comprises the aerosol generator exceeding a predetermined temperature, and wherein the indication comprises an indication that the aerosol generator has overheated, wherein the aerosol generator comprises a heating element.

10. An aerosol provision system according to claim 6, wherein the first predetermined criterion comprises the aerosol provision device exceeding a predetermined temperature, and wherein the indication comprises an indication that the aerosol provision device has overheated.

11. An aerosol provision system according to claim 6, wherein the aerosol provision device is further configured to:
generate a second signal, in response to determining that a second predetermined criterion is satisfied; and
send the second signal to the tactile indicator;
wherein the tactile indicator is configured to adopt a third configuration in response to the tactile indicator receiving the second signal, wherein the third configuration is different from the first configuration and the second configuration.

12. An aerosol provision system according to claim 6, wherein the tactile indicator comprises an adhesive surface for attaching the tactile indicator to the aerosol provision device.

13. An aerosol provision system according to claim 6, wherein the tactile indicator is located on the aerosol provision device.

14. An aerosol provision system according to claim 6, wherein the tactile indicator is located on an external surface of the aerosol provision device.

15. An aerosol provision system according to claim 6, wherein the aerosol provision system further comprises a cartridge configured to engage with the aerosol provision device.

16. An aerosol provision system according to claim 15, wherein the indication comprises an operation or characteristic of the cartridge.

17. An aerosol provision system according to claim 16, wherein the indication comprises an indication that the cartridge is received by the aerosol provision device.

18. An aerosol provision system according to claim 15, wherein the tactile indicator is configured to adopt a first configuration when the cartridge is not received by the aerosol provision device, and is configured to adopt a second configuration, which is different from the first configuration, when the cartridge is received by the aerosol provision device.

19. An aerosol provision system according to claim 18, wherein the cartridge is a first cartridge, and wherein the aerosol provision device is further configured to receive a second cartridge, which is different from the first cartridge;
wherein the tactile indicator is configured to adopt a third configuration, which is different from the first configuration and the second configuration, when the second cartridge is received by the aerosol provision device.

20. An aerosol provision system according to claim 15, wherein the aerosol provision device comprises the tactile indicator.

21. An aerosol provision system according to claim 15, wherein the cartridge comprises the tactile indicator.

22. An aerosol provision system according to, wherein the tactile indicator is configured to display an indication in Braille.

23. An aerosol provision system according to claim 6, wherein the tactile indicator comprises a tactile display.

24. A cartridge for an aerosol provision system comprising the cartridge and an aerosol provision device, wherein the cartridge comprises:
a tactile indicator for providing an indication of an operation or characteristic of the aerosol provision system.

25. A tactile indicator for providing an indication of an operation or characteristic of an aerosol provision device, wherein the tactile indicator is configured to be attached to an aerosol provision device;
wherein the tactile indicator comprises an adhesive surface for attaching the tactile indicator to the aerosol provision device.

26. A tactile indicator according to claim 25, wherein the adhesive surface is configured for releasably attaching the tactile indicator to the aerosol provision device.

27. An aerosol provision device for generating an aerosol in an aerosol provision system, wherein the aerosol provision device further comprises a tactile indicator for providing an indication of an operation or characteristic of the aerosol provision system.

28. A method of providing an indication of an operation or characteristic of an aerosol provision system configured to generate an aerosol, the method comprising:
in response to a first predetermined criterion being satisfied, changing a configuration of the tactile indicator from a first configuration to a second configuration.

29. The method according to claim 28, wherein the method further comprises:
generating a first signal, in response to determining that the first predetermined criterion is satisfied and
changing the configuration of the tactile indicator from the first configuration to the second configuration in response to the tactile indicator receiving the second signal.

30. The method according to claim 28, wherein the method further comprises:
generating a second signal, in response to determining that a second predetermined criterion is satisfied; and
changing the configuration of the tactile indicator to adopt a third position, in response to the tactile indicator receiving the second signal, wherein the third configuration is different from the first configuration and the second configuration.

31. A method according to claim 28, wherein the method further comprises:
receiving a cartridge via an aerosol provision device; wherein the first predetermined criterion comprises the cartridge being received by the aerosol provision device.

32. A method of retrofitting an aerosol provision system, comprising an aerosol provision device for generating an aerosol, wherein the method comprises:
attaching a tactile indicator, for providing an indication of an operation or characteristic of the aerosol provision system, to the aerosol provision system.

33. A method according to claim 28, wherein the method comprises attaching the tactile indicator to the aerosol provision system via an adhesive surface from the tactile indicator.
